(19) United States
(12) Patent Application Publication
(10) Pub. No.: US 2006/0013126 A1
(43) Pub. Date: Jan. 19, 2006

(54) Tunnel failure notification apparatus and method

(75) Inventors: Hirotomo Yasuoka, Yokohama (JP); Tatsuya Fukuyo, Yokohama (JP); Jun Ito, Yokohama (JP); Sachito Shibata, Yokohama (JP); Akira Yonenaga, Yokohama (JP); Naomi Ojima, Yokohama (JP); Michiko Osawa, Yokohama (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/010,900

(22) Filed: Dec. 13, 2004

(30) Foreign Application Priority Data
Jul. 13, 2004 (JP) 2004-205595

(51) Int. Cl. H04L 1/00

(52) U.S. Cl. 370/217

(57) ABSTRACT

When a failure occurs in the line of a communication network for transmitting packets using a tunnel, the disconnection messages of a plurality of tunnels which pass through the line are unified, and the occurrence of the failure is notified to an adjacent node for each line. Then, the tunnels are disconnected or switched based on a failure notice.

### BACKGROUND OF THE INVENTION

1. Field of the Invention

The present invention relates to an apparatus for notifying a tunnel failure in an IP network for providing highly reliable services by applying traffic engineering, such as real time application and the like, including a mobile Internet protocol (IP) network and voice-over Internet protocol (VoIP), and by reserving line resources (band), and a method thereof.

2. Description of the Related Art

A tunnel technology is a technology for encapsulating a packet described by a specific protocol, using another protocol and communicating (for example, see Patent Reference 1). According to this technology, a plurality of tunnels can be built in one physical line. RFC3209 (Non-patent reference 1) discloses extensions to resource reservation protocol (hereinafter called “RSVP”) for label-switched paths (LSP) tunnels.

If a tunnel (band) reserved on a network has a line failure when transmission is conducted by RSVP, using the tunnel technology in order to transmit IP packets at high speed, RSVP transmits a disconnection message to an adjacent node for all tunnels which exist in the line. If a head end, which is a tunnel start node, receives the disconnection message, the head end disconnects the relevant tunnel, based on the received disconnection message. If tunnels comprise active ones and standby ones, an active tunnel is switched at the time of tunnel disconnection.

FIG. 1A shows the configuration of an IP network composed of four routers. Routers 11 and 14 shown in FIG. 1A are routers for a start node (head end) and an end node (tail end), respectively, and routers 12 and 13 are routers for relay nodes (core #A and core #B, respectively) for relaying IP packets between the start and end nodes.

FIG. 1B shows one tunnel configuration in the IP network shown in FIG. 1A. The head end and core #A, the core #A and core #B, and the core #B and tail end are all connected by physical lines 21, 22 and 23, respectively, each with 100M band, and n tunnels 1 through n each with 1M band are established in each line.

In this network configuration, if a line failure occurs between core #B and the tail end, as shown in FIG. 1C, core #B transmits failure notices (disconnection messages) for n tunnels to an upstream core #A (step 31). Upon receipt of the disconnection messages for n tunnels from the core #B, the core #A transmits the disconnection messages for n tunnels to the upstream head end.

The head end disconnects failed tunnels, using the reception of the disconnection message for each tunnel as a trigger (steps 32-1 through 32-n). Since no failure occurs in the core #A which is the adjacent node of the head end, the head end re-establishes a definition of tunnel “by explicit”. “By explicit” means to explicitly designate the route of a tunnel. If the line failure is not recovered, setting NG occurs in the core #B. In this case, a tunnel is repeatedly re-established until setting OK is returned from the tail end.

FIG. 1D shows the configuration of another IP network composed of eight routers. Routers 41 and 46 shown in FIG. 1D are routers for the head end and the tail end, respectively, and routers 42 through 45, 47 and 48 are routers for relay nodes (core #A, core #B, core #C, core #D, core #E and core #F, respectively).

If in this network configuration, fast reroute which is a high-speed failure switching for a tunnel is installed, an active tunnel and a standby tunnel are conventionally switched in the core #A, which is the node (point of local repair (PLR)) in which the start point of an active system coincides with that of a standby system.

The active tunnel passes through core #A, core #B, core #C and core #D, and the standby tunnel passes through core #A, core #E, core #F and core #D. For example, a failure occurs in core #B, which is the adjacent node of core #A, core #A can switch a tunnel to a standby system.

The hello function of RSVP is a function to transmit/receive a hello message to/from an adjacent node in a specific cycle and confirm each other that each other's RSVP protocol is in a normal state (service state). The hello message is exchanged for each line of each node. Its transmission/reception cycle is called “hello interval timer”, and if this timer clocks the interval time, a hello message (request) is transmitted.

For example, when a hello message (request) is exchanged between nodes A and B, as shown in FIG. 1E, node A resets the hello interval timer after transmitting the hello message (request) to node B (step 51).

Upon receipt of the hello message (request) from node A, node B returns a hello message (Ack) for the received hello message (request). Therefore, there is no need to transmit a hello message (request) using time-out as a trigger. Therefore, the hello interval timer is reset (step 52). A hello life timer is also reset (step 53).

If the hello message (request) or hello message (Ack) is not received within the time-out time of the hello life timer, it is regarded that a failure has occurred in an adjacent node. Upon receipt of the hello message (Ack) from node B, node A resets the hello life timer (step 54).
Patent Reference 1: Japanese Published Patent Application No. 2002-314582
Non-patent Reference 1: “RSVP-TE: Extensions to RSVP for LSP Tunnels”, RFC3209, 2001.

However, the above-mentioned conventional line failure notification method has the following problems.

(1) Sometimes a lot of tunnels exist in one line depending on network topology. In that case, a lot of tunnel disconnections occur when a line failure occurs. In this case, since a lot of tunnel disconnection messages must be notified to an adjacent node and a lot of messages flow into the network, there is a possibility that the load of the network may increase. Since RSVP is user datagram protocol (UDP), their delivery cannot be confirmed. When there is a lot of tunnel disconnections, messages are lost due to packet loss or the like. Therefore, there is a possibility that tunnel disconnection may not be rapidly made.

(2) If it looks to the head end that no failure occurs in an adjacent node (core #A in FIG. 1D) even when a line failure is not recovered, RSVP transmits a tunnel set request for a disconnected tunnel to a downstream node (only to a tunnel designated by explicit). Therefore, until the line failure is recovered, an unnecessary message continues to flow in a network and there is a possibility that the load of the network may increase.

(3) Fast reroute can switch a tunnel only when a failure occurs in an adjacent node. If a failure occurs between the core #B and core #C or between the core #C and core #D in the network configuration shown in FIG. 1D, tunnel switching by fast reroute cannot be performed.

### SUMMARY OF THE INVENTION

It is an object of the present invention to improve the detection speed of a tunnel failure and to reduce the load of a network when a line failure occurs.

It is another object of the present invention to make fast reroute possible even when a failure occurs in a node other than the adjacent node of a node in which the respective start points of active and standby systems coincide with each other.

The first tunnel failure notification apparatus of the present invention comprises a detection device and a notification device. The first tunnel failure notification apparatus notifies an adjacent node of the occurrence of a tunnel failure in a communication network for transmitting packets using a tunnel. The detection device detects the occurrence of a failure in the line of the communication network, and notification device unifies a plurality of disconnection messages of the tunnels which pass through the failed line and notifies an adjacent node for each failed line.

The second tunnel failure notification apparatus of the present invention comprises a receiving device and a notification device. The second tunnel failure notification apparatus notifies an adjacent node of the occurrence of a tunnel failure in a communication network for transmitting packets using a tunnel. The receiving device receives a failure notice that represents a plurality of disconnection messages of the tunnels which pass through a failed line and notifies the occurrence of the failure for each failed line, from the first adjacent node when the failure occurs in the line of the communication network. The notification device notifies the second adjacent node of the occurrence of the failure for each line, based on the received failure notice.

The first tunnel failure processing apparatus of the present invention comprises a receiving device and a control device. The first tunnel failure processing apparatus disconnects tunnels when a tunnel failure occurs in a communication network for transmitting packets using a tunnel. The receiving device receives a failure notice that represents a plurality of disconnection messages of the tunnels which pass through a failed line and notifies the occurrence of the failure for each failed line from an adjacent node when the failure occurs in the line of a communication network. The control device disconnects a plurality of tunnels, based on the received failure notice and then refrains from re-establishing the plurality of tunnels until receiving a recovery notice for notifying the recovery of the failure.

The second tunnel failure processing apparatus of the present invention comprises a receiving device and a control device. The second tunnel failure processing apparatus switches tunnels when a tunnel failure occurs in a communication network for transmitting packets using a tunnel. The receiving device receives a failure notice that represents a plurality of disconnection messages of the tunnels which pass through a failed line and notifies the occurrence of the failure for each failed line from an adjacent node when the failure occurs in the line of a communication network. The control device switches active tunnels included the plurality of tunnels to standby tunnels which takes an alternative route, based on the received failure notice.

### BRIEF DESCRIPTION OF THE DRAWINGS

FIG. 1A shows the first network configuration;

FIG. 1B shows a tunnel configuration;

FIG. 1C is the conventional failure notification sequence chart;

FIG. 1D shows the second network configuration;

FIG. 1E is the conventional hello message sequence chart;

FIG. 2A shows the basic configuration of the tunnel failure notification apparatus and tunnel failure processing device of the present invention;

FIG. 2B is the failure notification sequence chart of the present invention;

FIG. 3 shows the module configuration of a router;

FIG. 4 shows network addresses;

FIG. 5 shows the first line information;

FIG. 6 shows the second line information;

FIG. 7 shows the third line information;

FIG. 8 shows the fourth line information;

FIG. 9 shows the format of the first Hello message;

FIG. 10 shows the format of a RECORD_ROUTE object;

FIG. 11 shows the format of Common Header;

FIG. 12 shows the format of the second Hello message;

FIG. 13 shows the transmission of a path message;

FIG. 14 shows the transmission of a hello message including a RECORD_ROUTE object;

FIG. 15 is a process sequence chart at the time of the detection of a failure;

FIG. 16 is a process sequence chart at the time of the reception of the first hello message;

FIG. 17 is a sequence chart showing the process of suppressing the re-establishment of a tunnel;

FIG. 18 is a process sequence chart at the time of the detection of recovery;

FIG. 19 is a process sequence chart at the time of the reception of the second hello message;

FIG. 20 shows a network configuration composed of two types of routers;

FIG. 21 shows a connection method between routers;

FIG. 22 shows the first management data;

FIG. 23 shows the second management data; and

FIG. 24 is a flag analysis sequence chart.

### DESCRIPTION OF THE PREFERRED EMBODIMENTS

The preferred embodiments of the present invention are described below with reference to the drawings.

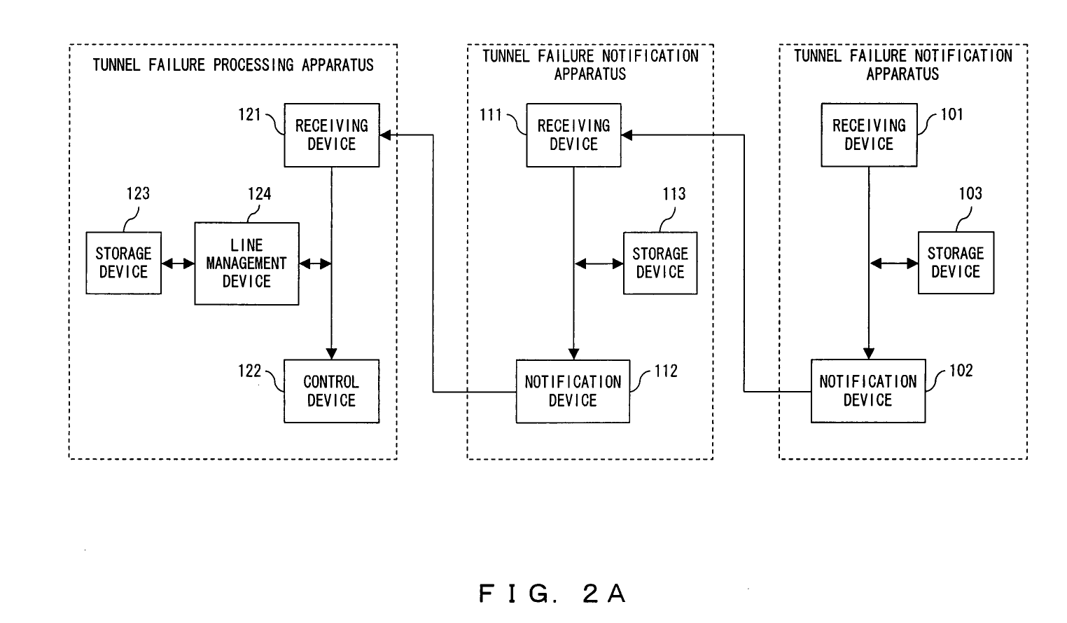

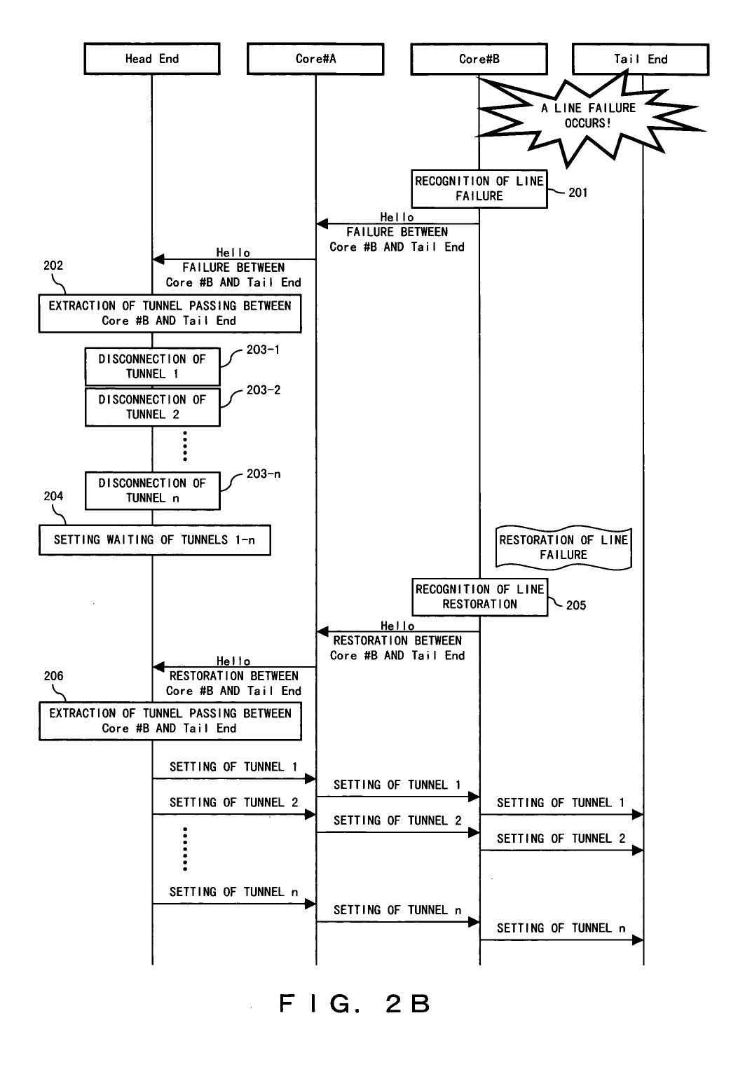

FIG. 2A shows the basic configuration of the tunnel failure notification apparatus and tunnel failure processing device of the present invention.

The tunnel failure notification apparatus in the first aspect of the present invention comprises a detection device 101 and a notification device 102. The tunnel failure notification apparatus notifies an adjacent node of the occurrence of a tunnel failure in a communication network for transmitting packets using a tunnel. The detection device 101 detects the occurrence of the failure in the line of the communication network. The notification device 102 unifies a plurality of disconnection messages of the tunnels which pass through the failed line and notifies an adjacent node for each failed line.

The tunnel failure notification apparatus in the second aspect of the present invention further comprises a storage device 103 in addition to the tunnel failure notification apparatus in the first aspect. The storage device 103 stores information about a failed line. The notification device 102 notifies an adjacent node of the occurrence of the failure when line information is abnormal.

According to the tunnel failure notification apparatus in the first or second aspect of the present invention, since the disconnection messages of a plurality of tunnels under the control of a failed line are unified together and are notified to an adjacent node, a tunnel failure can be notified at high speed, and accordingly, the load of a network can be reduced.

The tunnel failure notification apparatus in the third aspect comprises a receiving device 111 and a notification device 112. The tunnel failure notification apparatus notifies an adjacent node of the occurrence of a tunnel failure in a communication network for transmitting packets using a tunnel. The receiving device 111 receives the failure notice that represents the disconnection messages of a plurality of tunnels which pass through a failed line and notifies the occurrence of the failure for each failed line, from the first adjacent node when the failure occurs in the line of the communication network. The notification device 112 notifies the second adjacent node of the occurrence of the failure for each line, based on the received failure notice.

The tunnel failure notification apparatus in the fourth aspect of the present invention further comprises a storage device 113 in addition to the tunnel failure notification apparatus in the third aspect. The storage device 113 stores information about a failed line. The notification device 112 notifies the second adjacent node of the occurrence of the failure when line information is abnormal.

According to the tunnel failure notification apparatus in the third or fourth aspect of the present invention, since the disconnection messages of a plurality of tunnels under the control of a failed line are unified together and are notified to an adjacent node, as in the tunnel failure notification apparatus in the first or second aspect, a tunnel failure can be notified at high speed, and accordingly, the load of a network can be reduced.

The tunnel failure processing apparatus in the fifth aspect of the present invention comprises a receiving device 121 and a control device 122. The tunnel failure processing apparatus disconnects tunnels when a tunnel failure occurs in a communication network for transmitting packets using a tunnel. The receiving device 121 receives the failure notice that represents a plurality of disconnection messages of the tunnels which pass through a failed line and notifies the occurrence of the failure for each failed line, from an adjacent node when the failure occurs in the line of the communication network. The control device 122 disconnects a plurality of tunnels, based on the received failure notice and then refrains from re-establishing the plurality of tunnels until receiving a recovery notice for notifying the recovery of the failure.

The tunnel failure processing apparatus in the sixth aspect of the present invention further comprises a storage device 123 and a line management device 124 in addition to the tunnel failure processing apparatus in the fifth aspect. The storage device 123 stores information about a plurality of lines in a communication network. The line management device 124 modifies information about a failed line from normal to abnormal when receiving a failure notice. The control device 122 disconnects a plurality of tunnels when the information of the failed line is modified to abnormal.

According to the tunnel failure processing apparatus in the fifth or sixth aspect of the present invention, since tunnels under the control of a failed line are refrained from re-establishing until the failure is recovered, the unnecessary re-establishment of tunnels can be suppressed, and accordingly, the load of a network can be reduced.

The tunnel failure processing apparatus in the seventh aspect of the present invention comprises a receiving device 121 and a control device 122. The tunnel failure processing apparatus switches tunnels when a tunnel failure occurs in a communication network for transmitting packets using a tunnel. The receiving device 121 receives the failure notice that represents a plurality of disconnection messages of the tunnels which pass through a failed line and notifies the occurrence of the failure for each failed line, from an adjacent node when the failure occurs in the line of the communication network. The control device 122 switches an active tunnel included the plurality of tunnels to a standby tunnel which takes an alternative route, based on the received failure notice.

The tunnel failure processing apparatus in the eighth aspect of the present invention further comprises a storage device 123 and a line management device 124. The storage device 123 stores information about a plurality of lines in a communication network. The line management device 124 modifies information about a failed line from normal to abnormal when receiving a failure notice. The control device 122 switches an active tunnel to a standby tunnel when the information of the failed line is modified to abnormal.

According to the tunnel failure processing apparatus in the seventh or eighth aspect of the present invention, a line failure can be recognized by a failure notice for each line even when the failure occurs in a node other than the adjacent node of a node in which the respective start points of active and standby systems coincide with each other. Accordingly, a active tunnel which passes through a failed line can be switched to a standby tunnel which takes an alternate route.

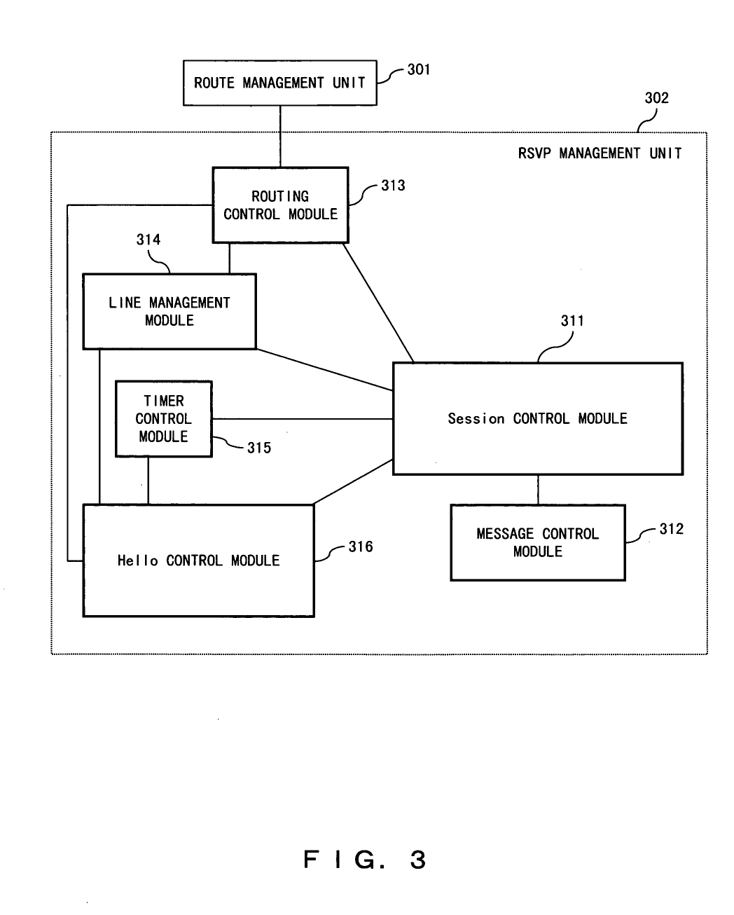

The detection device 101, for example, corresponds to a routing control module 313 shown in FIG. 3, which is described later. The notification device 102 or 112, for example, corresponds to a hello control module 316 shown in FIG. 3. The receiving device 111 or 121, for example, corresponds to a session control module 311 shown in FIG. 3. The control device 122, for example, corresponds to a session control module 311 shown in FIG. 3. The line management device 124, for example, corresponds to a line management module 314 shown in FIG. 3. The storage device 103, 113 or 123, for example, corresponds to memory in a router.

According to the present invention, when a line failure occurs, a tunnel failure can be detected at high speed without transmitting a lot of tunnel disconnection messages. Thus, highly reliable services can be provided.

Even if a failure occurs in a node other than the adjacent node of a node in which the respective start points of active and standby systems coincide with each other, fast reroute can be applied.

Major improvements in the present invention are as follows.

(1) Transmission of a Tunnel Disconnection Message for Each Line by a Hello Message

Conventionally, even when a line failure occurs, a disconnection message is transmitted for each tunnel under the control of the line. However, in the present invention, messages are unified so that a tunnel failure can be notified at high speed. Thus, the tunnel failure can be notified at high speed, and simultaneously, the flow of a lot of messages into a network can be suppressed, and accordingly, the load of the network can be reduced.

(2) Prevention of Unnecessary Tunnel Re-Establishment

Conventionally, even when a line failure occurs, the relevant tunnel is re-established after being disconnected. However, in the present invention, the re-establishment of tunnels under the control of the relevant line is suppressed until the head end recognizes a failed line and receives a recovery notice corresponding to the line. A recovery notice is issued for each line as the failure notice is. Thus, the unnecessary flow of messages into a network can be suppressed, and accordingly, the load of a network can be reduced.

(3) Application of Fast Reroute

Conventionally, only when a failure occurs in the adjacent node of a node in which the respective start points of an active system and a standby system coincide with each other, fast reroute can be applied. However, in the present invention, a node in which the respective start points of active and standby system coincide with each other can recognize a line failure by the failure notice in (1) and can apply fast reroute even when the failure occurs in a node other than the adjacent node.

FIG. 2B is a failure notification sequence chart with the above-mentioned improvements at the time of the occurrence of a line failure. When a line failure occurs between core #B and the tail end in the network shown in 1A, core #B transmits a hello message for notifying an upstream core #A of the occurrence of the line failure (step 201). Upon receipt of the hello message from core #B, core #A transmits a hello message for a failure notice to an upstream head end.

Upon receipt of the hello message, the head end selects tunnels which pass through between core #B and the tail end where the failure occurs (step 202), and disconnects the tunnels (step 203-1 through 203-n). Then, the head end does not set the tunnels until the line failure is recovered (step 204).

Then, when the line failure between core #B and the tail end is recovered, core #B transmits a hello message for notifying the failure recovery to an upstream core #A for each line (step 205). Upon the receipt of the hello message from core #B, core #A transmits a hello message for recovery notification to an upstream head end.

Upon receipt of the hello message, the head end selects tunnels which pass between core #B and the tail end where the failure is recovered (step 206), and re-establishes the definition of tunnel by explicit.

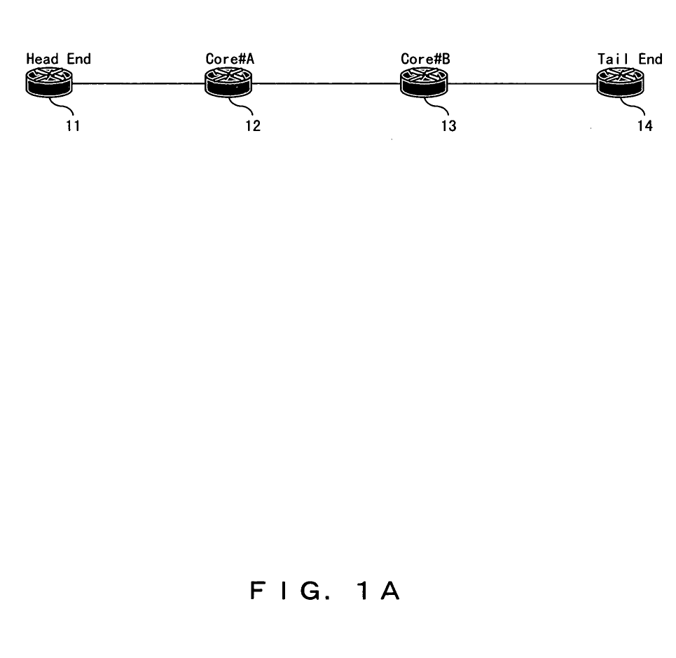

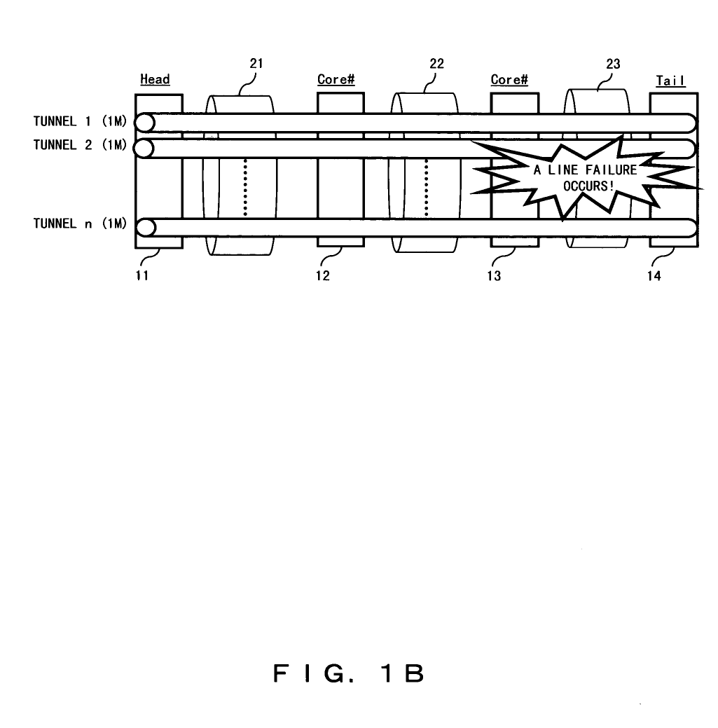

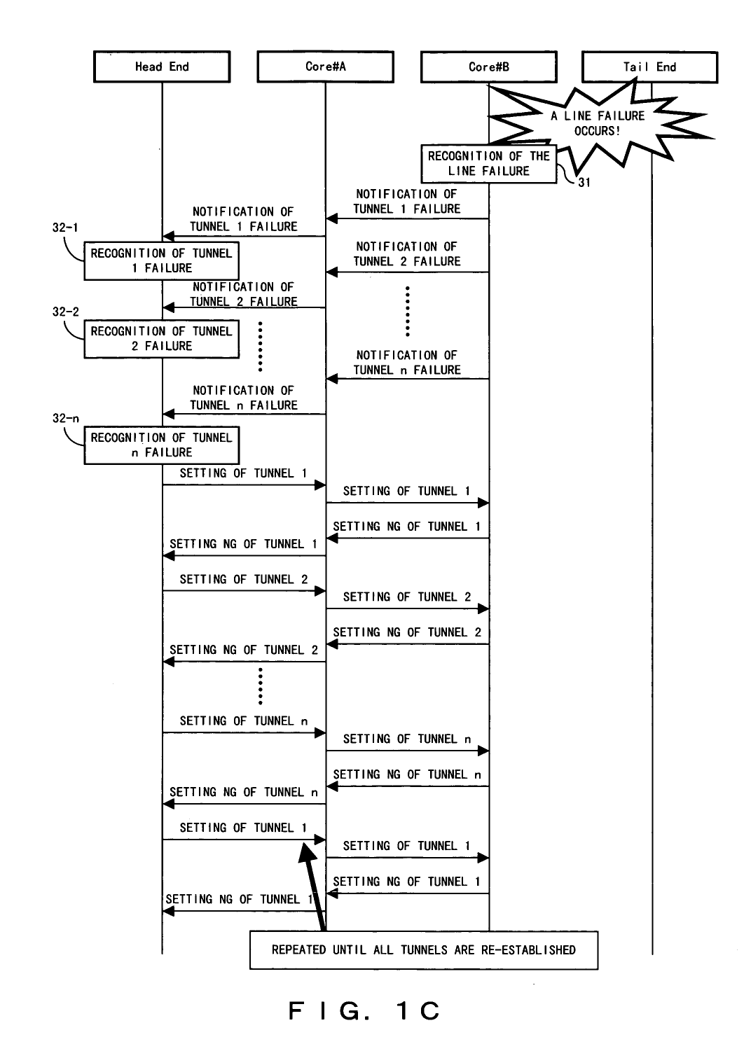

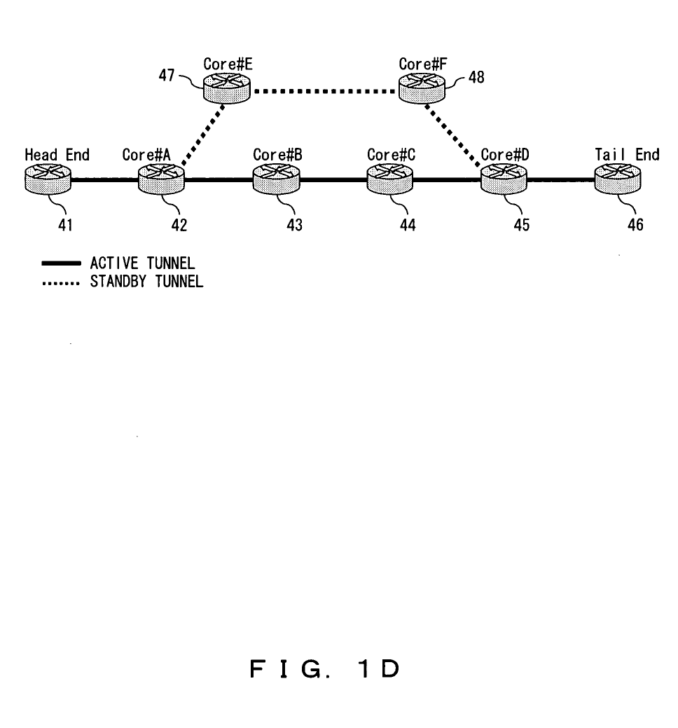

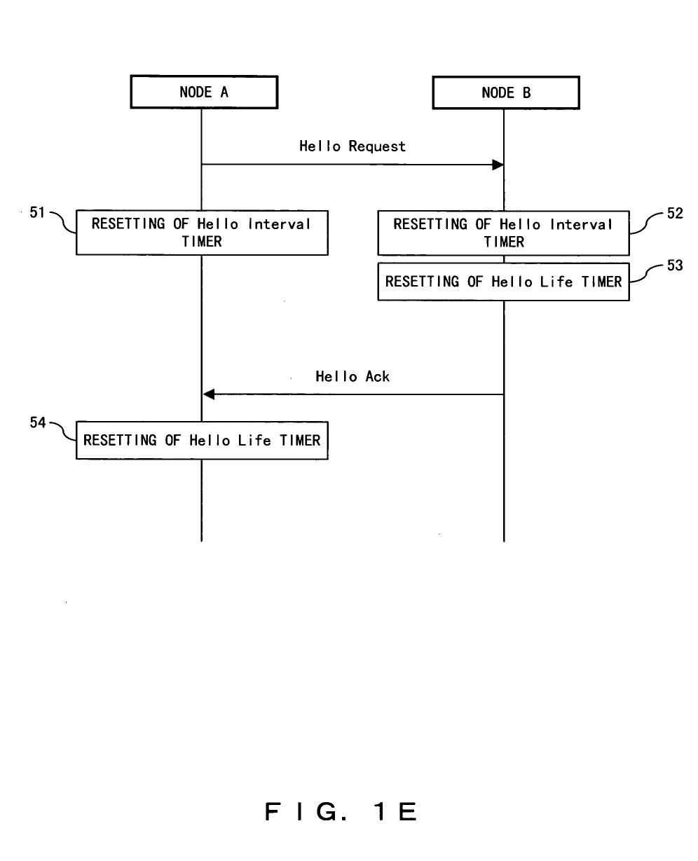

According to such failure notification sequence, the number of processes for failure notification can be greatly reduced, compared with the failure notification sequence shown in FIG. 1C. Since each tunnel is set after receiving the recovery notice of the line failure, an unnecessary tunnel setting process before recovery can be deleted.

FIG. 3 shows the module configuration common to each router in the preferred embodiment. The router shown in FIG. 3 comprises a route management unit 301 and an RSVP management unit 302. The RSVP management unit 302 comprises a session control module 311, a message control module 312, a routing control module 313, a line management module 314, a timer control module 315 and a hello control module 316. The route management unit 301 manages routes.

The session control module 311 of the RSVP management unit 302 performs the entire tunnel control, such as connection, disconnection, switching, refreshing and the like, and also receives/transmits an RSVP message. When receiving a hello message, the session control module 311 transfers the received message to the hello control module 316. The session control module 311 also has a function to refrain from connecting tunnels under the control of a failed line at the time of tunnel connection.

The message control module 213 analyzes, edits and compares an RSVP session control message object.

The routing control module 313 determines whether each tunnel address belongs to the relevant station and specifies its outgoing routes. The routing control module 313 determines whether route information is appropriate in the case of explicit and updates the information. Receiving a line failure notice, the routing control module 313 notifies the hello control module 316 of the line failure.

The line management module 314 manages line information and band information which are used in RSVP. The line management module 314 also issues a tunnel release request when a line failure occurs.

The timer control module 315 controls a session control timer (a path interval, a refresh interval and the like). The timer control module 315 also periodically starts the hello control module 316.

The hello control module 316 transmits/receives a hello message, makes an inquiry about whether a line failure occurs in the relevant node or whether a line failure is recovered, to the line management module 314 when transmitting a hello message, and transmits a message attaching failure/recovery information to the hello message.

If no line failure occurs in the relevant node and failure/recovery information is attached to a received hello message, the hello control module 316 updates line information managed by the line management module 314, and transmits a hello message attaching failure/recovery information by event driven.

If new failure information or new recovery information from an adjacent node is set in line information, the hello control module 316 stores the updated line information until receiving a recovery message or a failure message, respectively, and transmits a hello message in a specific cycle in accordance with the information. The hello control module 316 controls a hello timer (interval and life), and releases tunnels when detecting a hello error.

The respective functions of both the route management unit 301 and each module of the RSVP management unit 302 can be realized by hardware or software. If they are realized by software, both programs corresponding to the route management unit 301 and RSVP management unit 302, and data, such as line information and the like, are stored in the memory of a router, and the processes of both the route management unit 301 and RSVP management unit 302 are performed by the processor of the router executing the programs using the memory.

The program of the RSVP management unit 302 comprises the respective programs of the session control module 311, the message control module 312, the routing control module 313, the line management module 314, the timer control module 315 and the hello control module 316.

These programs and data are provided to a user via a communication network or a portable storage medium, and are loaded onto the memory of a router. In this case, the information processing device of a provider generates a carrier signal for carrying the programs and data, and transmits them to the information processing device of the user via a transmission medium in the communication network. For the portable storage medium, any computer-readable storage medium, such as a memory card, a flexible disk, an optical disk, a magneto-optical disk or the like, can be used.

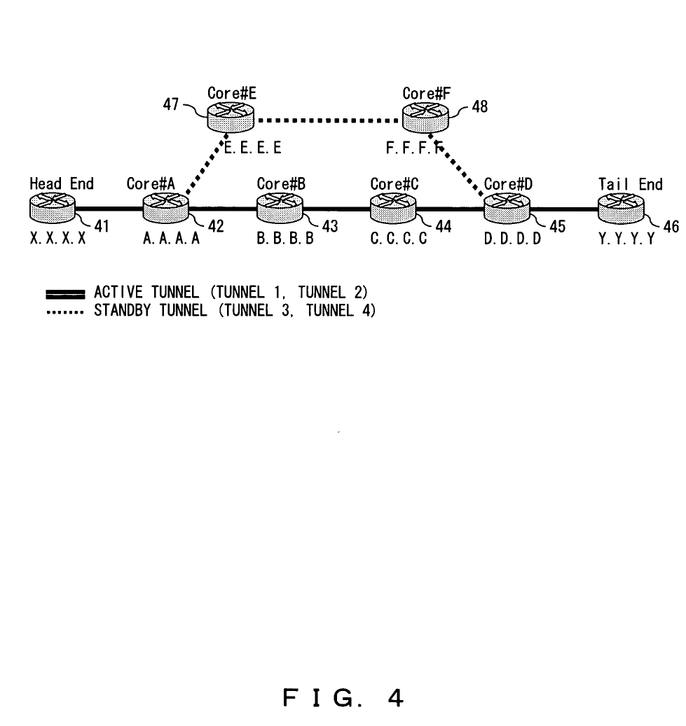

Next, the operation in the case where a line failure occurs between core #B and core #C in the network configuration shown in FIG. 1D is described with reference to FIGS. 4 through 8.

As shown in FIG. 4, it is assumed that the network addresses of the head end, the tail end, core #A, core #B, core #C, core #D, core #E and core #F are X.X.X.X, Y.Y.Y.Y, A.A.A.A, B.B.B.B, C.C.C.C, D.D.D.D, E.E.E.E and F.F.F.F, respectively. It is assumed that tunnels 1 and 2 are established as active tunnels between the head end and the tail end, and tunnels 3 and 4 are established as standby tunnels.

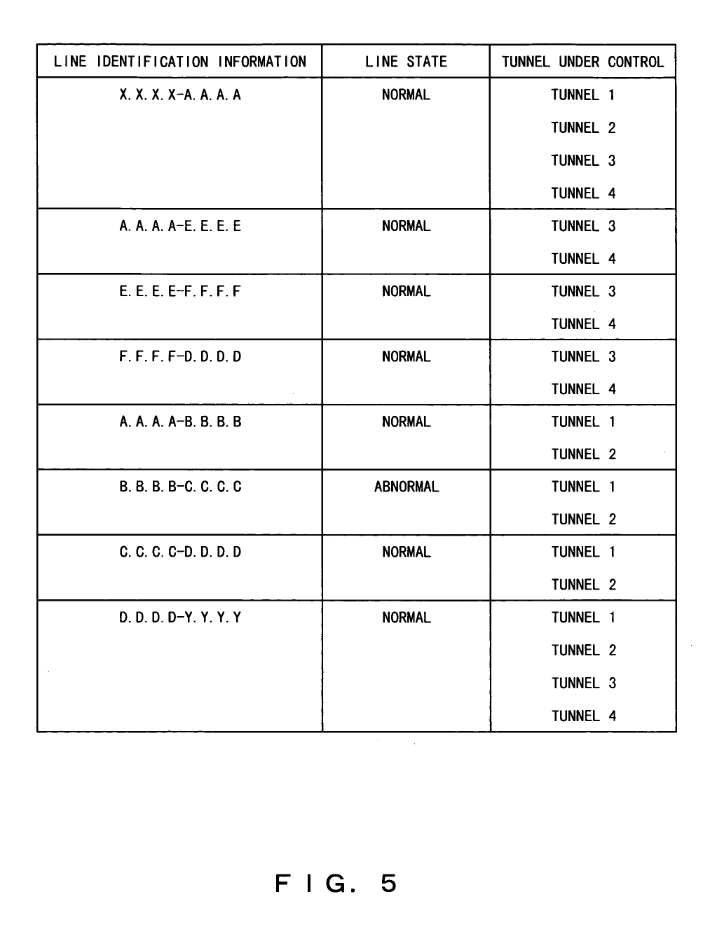

Data in the head end which is managed as line information by the line management module 314 is different from that in each node other than the head end. FIG. 5 shows line information stored in the head end. This line information includes information about all lines through which a tunnel passes. Line identification information is information for uniquely identifying a line, and comprises the respective network addresses of two nodes connected by a line. A line state indicates whether a line is normal or abnormal. A controlled tunnel contains the identification information of all tunnels which pass through the line.

When recognizing a failure between core #B and core #C, the head end updates the state of a line between “B.B.B.B and C.C.C.C” from “normal” to “abnormal”.

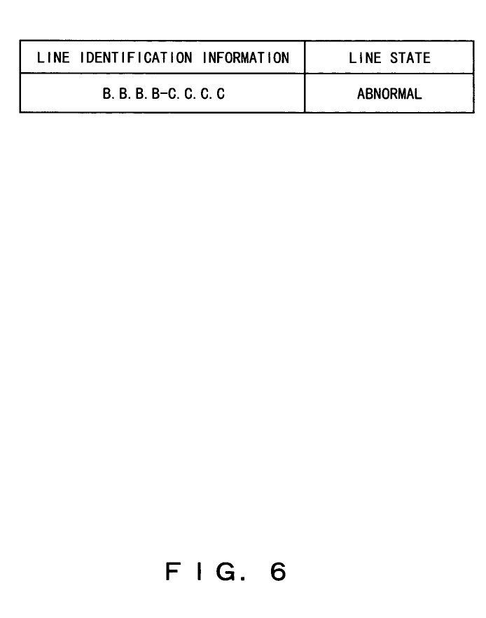

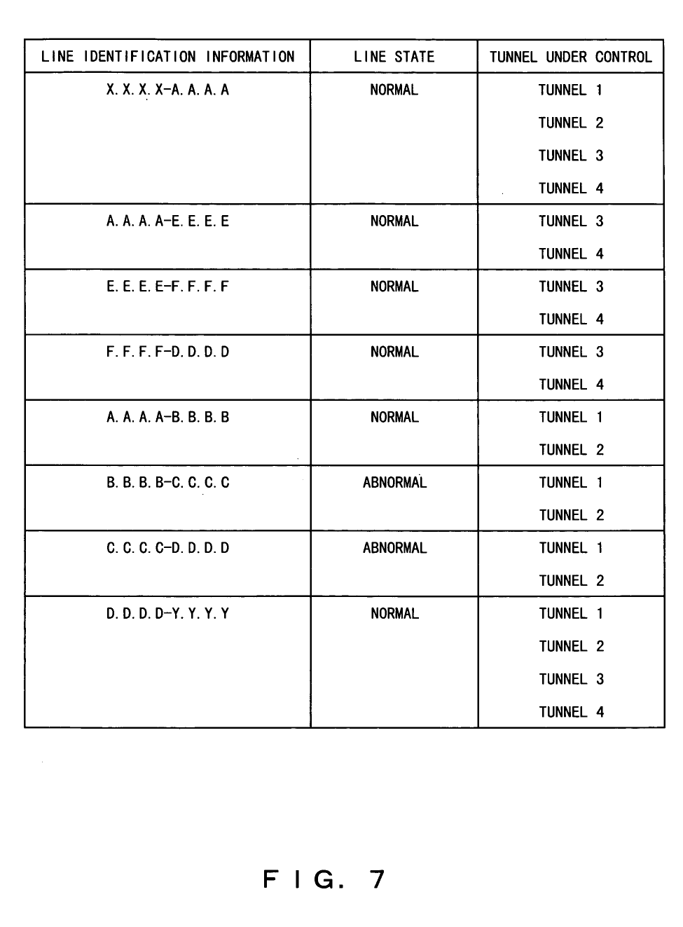

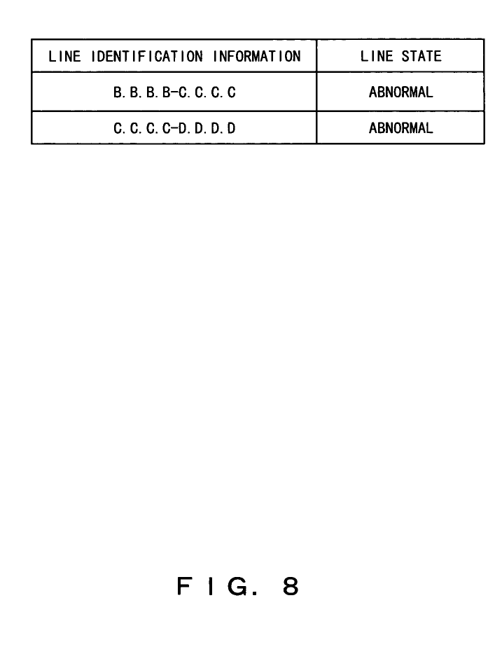

However, the line information shown in FIG. 6 is stored in each node other than the head end (core #A, core #B, core #C, core #D, core #E, core #F or the tail end). This line information is used to manage only “abnormal”, and the number of data, equal to that of the caused line failures, are generated. Therefore, for example, if a new failure occurs between core #C and core #D, the line information of the head end becomes as shown in FIG. 7, and the line information of each node other than the head end becomes as shown in FIG. 8.

When a line failure is recovered, data stored in the head end is updated from “abnormal” to “normal”. All data stored in the nodes except the head node is deleted. Therefore, at normal time where no failure occurs, no node stores the data shown in FIGS. 6 and 8 except for the head end.

When a tunnel is established by the prior art, without using the line information shown in FIGS. 5 through 8, a line state can also be managed using the line information of stored tunnel information. If this normality/abnormality of a line state is conventionally managed, the normality/abnormality of the line state can be updated based on a received hello message. If the normality/abnormality of a line state is not managed, a field for indicating the normality/abnormality can be added.

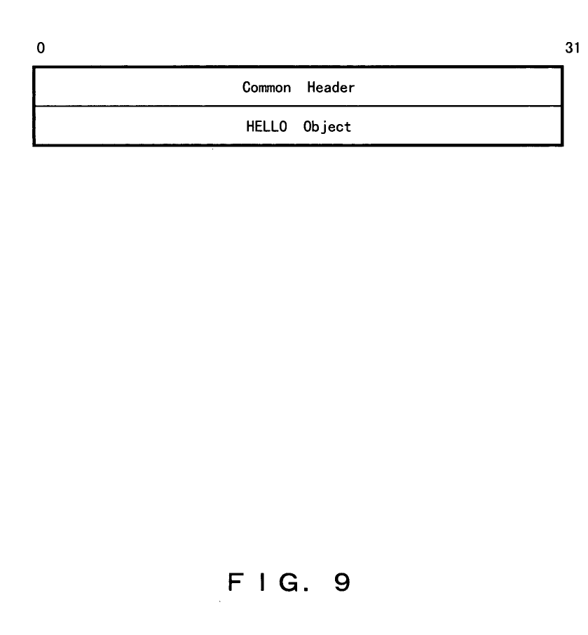

Next, a hello message used for failure notification is described with reference to FIGS. 9 through 14.

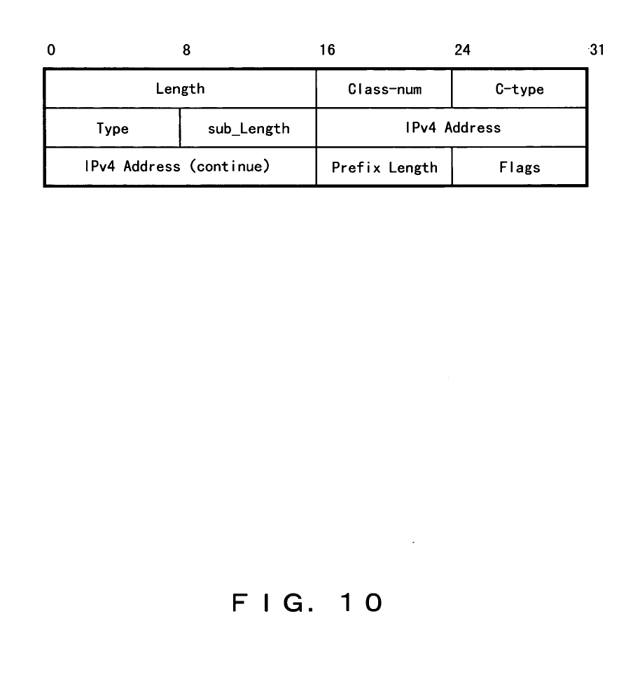

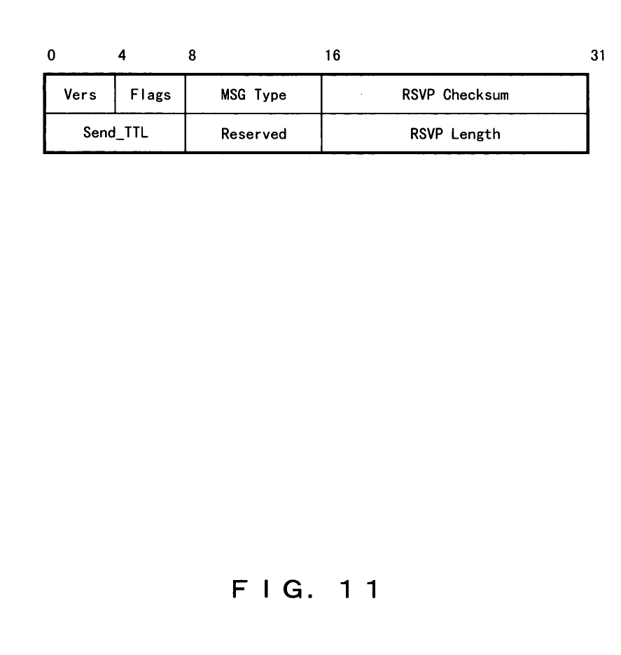

FIGS. 9 and 10 show the formats of an RSVP hello message and an RSVP RECORD_ROUTE object, respectively, which are stipulated in RFC3209. A common header included in the RSVP hello message shown in FIG. 9 has a format shown in FIG. 11.

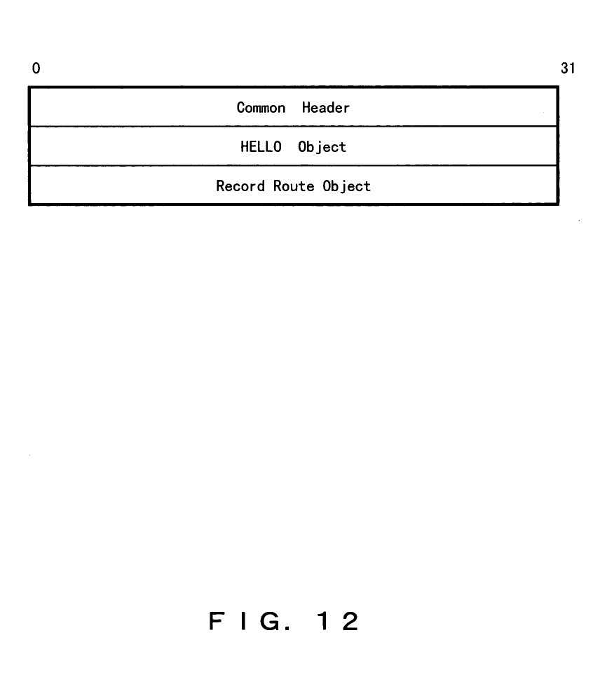

In this preferred embodiment, normally a hello message is transmitted in the format shown in FIG. 9. However, when a line failure occurs, a hello message is transmitted in a format obtained by combining the format shown in FIG. 9 with that shown in FIG. 10. The format of the latter hello message is as shown in FIG. 12.

If a line failure occurs between network addresses B.B.B.B (core #B) and C.C.C.C (core #C) in the network configuration shown in FIG. 4, each of nodes that detect the failure (core #B and core #C) writes the network address in which the line failure occurs, into the IPv4Address of the RECORD_ROUTE object shown in FIG. 10, and transmits a hello message to an adjacent node in the format shown in FIG. 12. The same data as conventional one is transmitted to the other data members shown in FIG. 12.

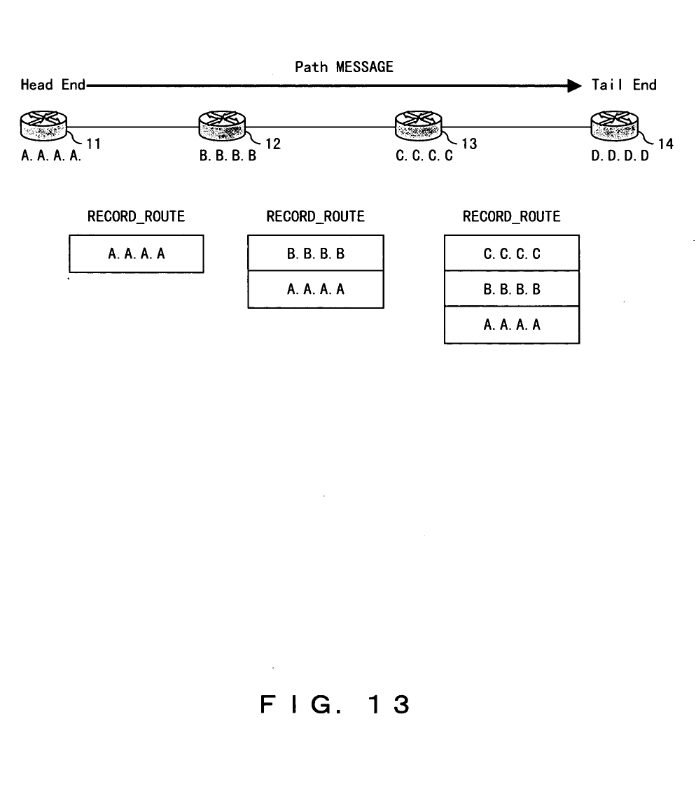

As shown in FIG. 13, a RECORD_ROUTE object is used as a function to record a route through which the path/resv message of RSVP is conventionally transferred. A head end router 11 always transmits a path message to which a RECORD_ROUTE object is attached.

If a RECORD_ROUTE object is attached to a received path/resv message, each of core routers 12 and 13 transmits a path/resv message with a RECORD_ROUTE object attached. If a RECORD_ROUTE object is attached to a received path message, a tail router 14 transmits a resv message with a RECORD_ROUTE object attached.

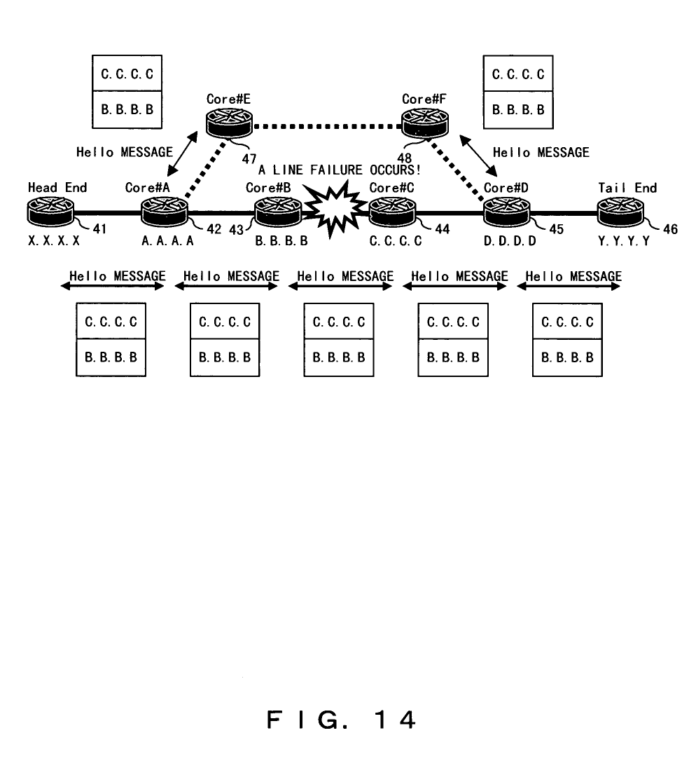

In this preferred embodiment, as shown in FIG. 14, this RECORD_ROUTE object is also applied to an RSVP hello message. A node that detects a line failure transmits a hello message with a RECORD_ROUTE object attached at the time of line failure. After that, the node periodically transmits a hello message with a RECORD_ROUTE object attached as usual. This operation continues until the failure is recovered.

In this example, a hello message with a RECORD_ROUTE object in which network addresses “B.B.B.B” and “C.C.C.C” are written is transmitted.

A node that receives a hello message with a RECORD_ROUTE object attached for the first time similarly sets a RECORD_ROUTE object by event driven and transmits a hello message to an adjacent node. For the second time and after, the node periodically transmits a hello message with a RECORD_ROUTE object attached as usual. This operation continues until the failure is recovered.

Next, a process of the case that there is a node in a network, which is not provided with the failure notification function of the present invention, is described.

In this case, flags included in the common header of an RSVP-TE message are used in order to solve a problem that a failure is not recognized. Flags are defined to be unused in RFC3209. Therefore, a node to which the failure notification of the present invention is applied transmits a message setting a unique value (for example, “3”, etc.) in flags indicating that the present invention is always applied. Thus, a node to which the present invention is not applied transmits a message without setting a unique value in flags (usually “0” is set). Therefore, it can be determined whether the present invention is applied.

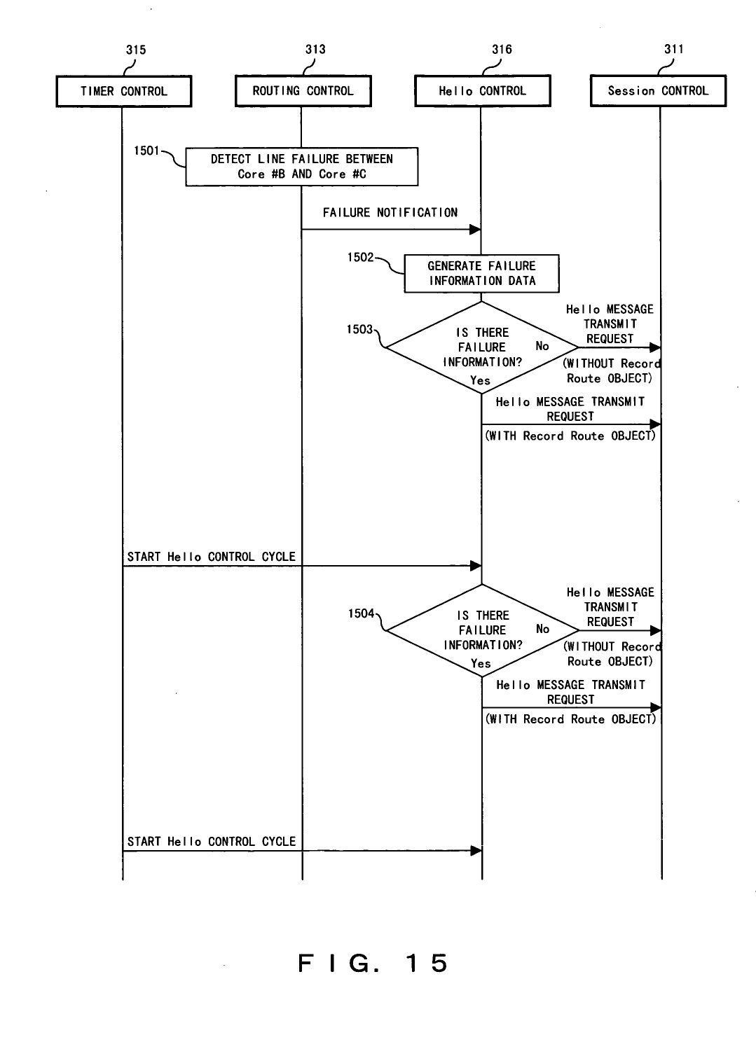

Next, the operations at the time of the occurrence of a failure and at the time of its recovery are described in more detail with reference to FIGS. 15 through 19.

FIG. 15 is a sequence chart showing an intra-node process at the time of the detection of a failure. If a line failure occurs between core #B and core #C in the network configuration shown in FIG. 4, each of the respective routing control modules 313 of core #B and core #C detects a failure (step 1501), and notifies the hello control module 316 of the occurrence of the failure.

The hello control module 316 generates the failure information data shown in FIG. 6 and transfers the data to the line management module 314 (step 1502). The line management module 314 stores the transferred failure information data in memory as line information.

Then, the hello control module 316 makes an inquiry about whether there is failure information, for the line management module 314 (step 1503). If there is the failure information data shown in FIG. 6, the line management module 314 notifies the hello control module 316 of its contents. If there is no failure information data, the line management module 314 notifies the hello control module 316 of the fact. When receiving the failure information data shown in FIG. 6, the hello control module 316 writes a network address in which a line failure occurs, into the IPv4Address of the RECORD_ROUTE object shown in FIG. 10. Then, the hello control module 316 transmits a hello message to an adjacent node (core #A or core #D) in the format shown in FIG. 12. In this case, the hello message is transmitted by event driven instead of periodical activation.

If there is no failure information data, the hello control module 316 transmits a hello message to an adjacent node in the format shown in FIG. 9 via the session control module 311.

After transmitting a hello message by event driven, the hello control module 316 is started in a specific cycle by the timer control module 315, and repeats the same process as in step 1503 (step 1503). As long as no failure in another line or no recovery of a failed line is detected, the hello control module 316 transmits a hello message with a RECORD_ROUTE object attached.

If a line failure is detected in the head end, in step 1502, the line management module 314 updates the line information shown in FIG. 5 which is stored in memory, from normal to abnormal.

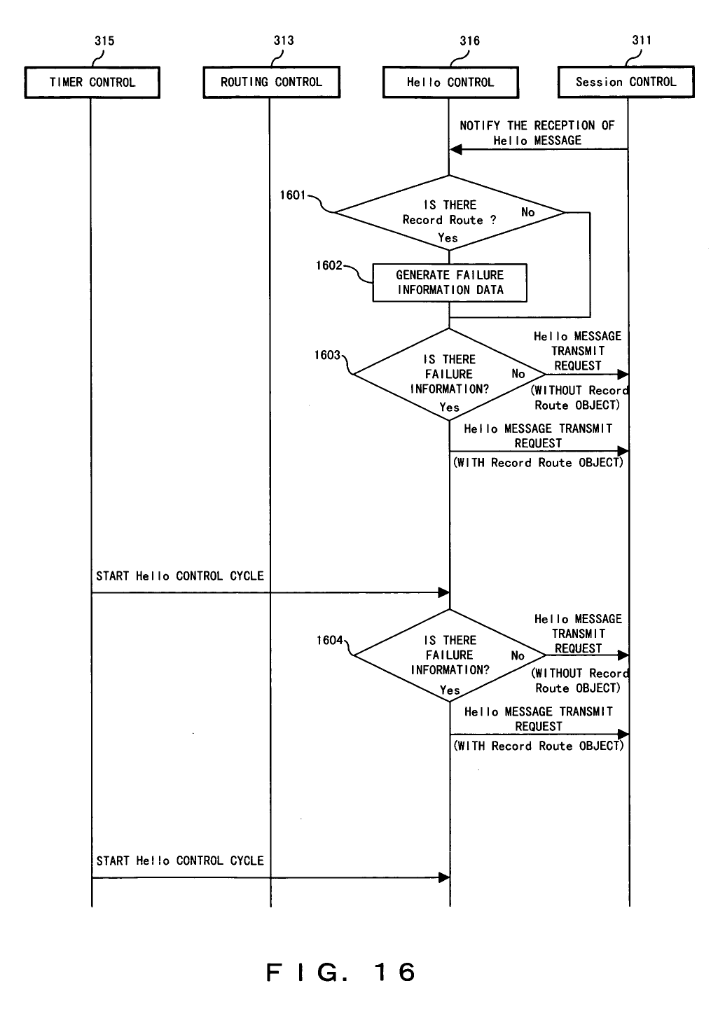

FIG. 16 is a sequence chart showing an intra-node process at the time of the reception of a hello message for notifying failure occurrence. The session control module 311 notifies the hello control module 316 of the reception of the hello message. The hello control module 316 checks whether a RECORD_ROUTE object is attached to the received hello message (step 1601).

If a RECORD_ROUTE object is attached, the hello control module 316 recognizes the occurrence of a failure, generates failure information data, based on the object and transfers the data to the line management module 314 (1602). The line management module 314 stores the transferred failure information data in memory as line information. In this case, if a receiving node is the head end, the line information shown in FIG. 5 is updated from normal to abnormal. If the receiving node is a node other than the head end, the line information shown in FIG. 6 is generated.

Then, the hello control module 316 performs the same process as in steps 1503 and 1504 shown in FIG. 15, and transmits a hello message with the same RECORD_ROUTE object attached as long as no failure in another line or no recovery of a failed line is detected (steps 1603 and 1604).

As described above, conventionally, even when a line failure occurs, the relevant tunnel is re-established after the tunnel is disconnected. For example, this is because as to a tunnel defined by explicit, if a line failure occurs between core #B and core #C in the network configuration shown in FIG. 4, the head end cannot recognize that the line failure occurs between core #B and core #C, in the protocol operation. In this preferred embodiment, this problem is solved using line information stored in the head end.

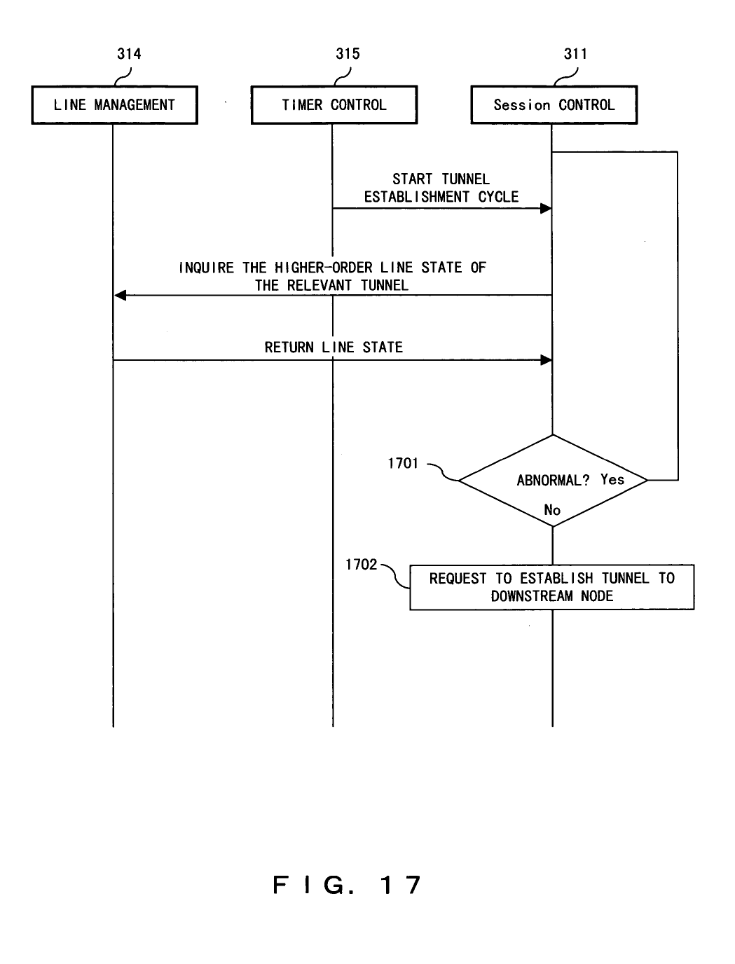

FIG. 17 is a sequence chart showing the process of suppressing the re-establishment of a tunnel in the failure notification sequence chart shown in FIG. 2. The timer control module 315 of the head end starts a tunnel establishment process by the session control module 311 in a specific cycle. The session control module 311 makes an inquiry about the state of a line through which the relevant tunnel passes, for the line management module 314. The line management module 314 refers to line information and notifies the session control module 311 of the state of the relevant line.

The session control module 311 checks the received line state (step 1701). If the state is abnormal, the session control module 311 refrains from transmitting a tunnel establish request and repeats the inquiry of the line state. If the line state becomes normal, the session control module 311 recognizes the recovery of a failure, and transmits a tunnel establish request to a down stream node (step 1702).

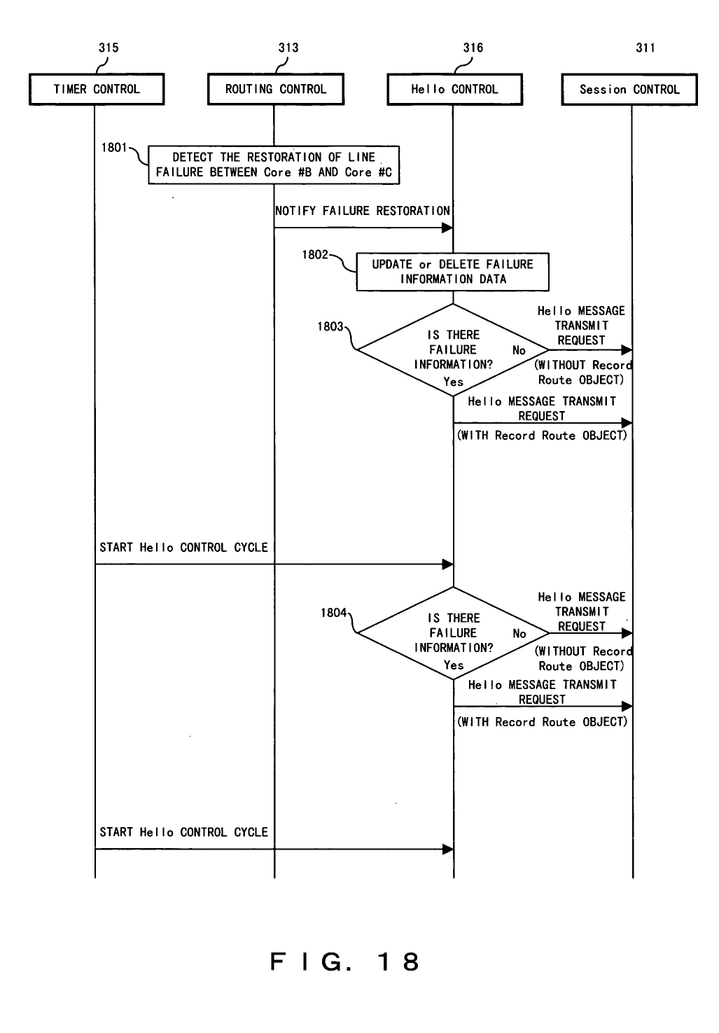

FIG. 18 is a sequence chart showing an intra-node process at the time of the detection of recovery. If a line failure caused between core #B and core #C in the network configuration shown in FIG. 4 is recovered, each of the respective routing control modules 313 of core #B and core #C detects recovery (step 1801), and notifies the hello control module 316 of the recovery of the failure. The hello control module 316 deletes the failure information data shown in FIG. 6 via the line management module 314 (step 1802).

Then, the hello control module 316 performs the same process as in steps 1503 and 1504 shown in FIG. 15, and transmits a hello message. In this case, since there is no failure information data, the hello control module 316 deletes a RECORD_ROUTE object from the hello message shown in FIG. 12, and transmits a hello message in the format shown in FIG. 9 to an adjacent node (step 1803). Then, as long as no new line failure or no recovery is detected, the hello control module 316 transmits a hello message in a specific cycle (step 1804).

If recovery is detected in the head end, in step 1802 the line information shown in FIG. 5 is updated from abnormal to normal via the line management module 314.

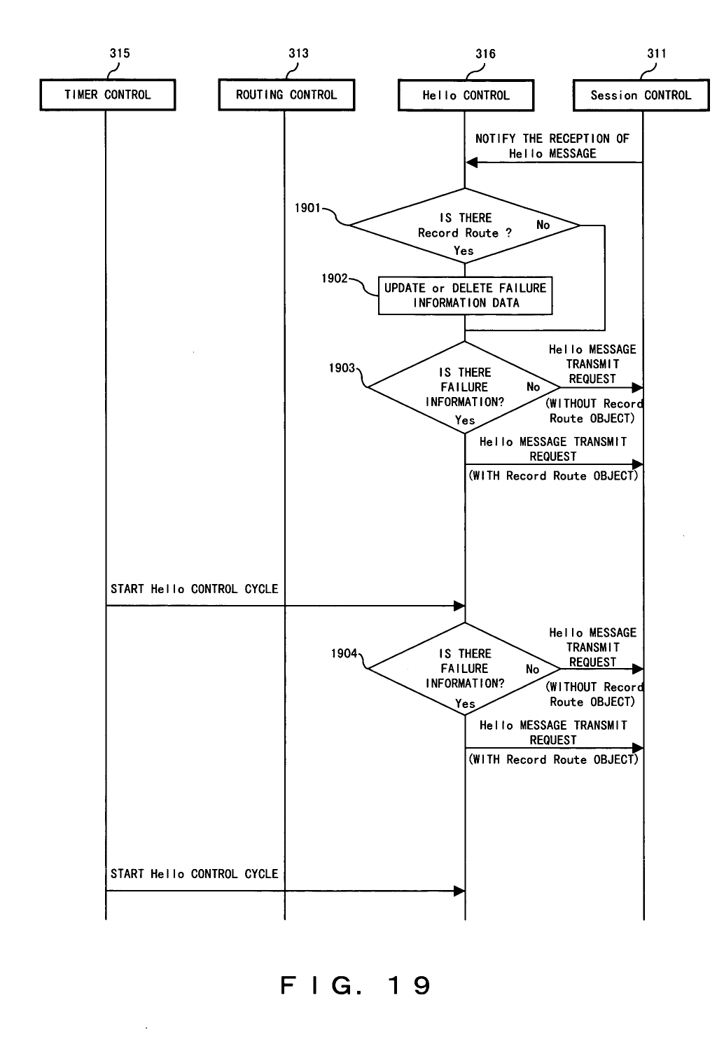

FIG. 19 is a sequence chart showing an intra-node process at the time of the reception of a hello message for notifying the recovery of a failure. The session control module 311 notifies the hello control module 316 of the reception of a hello message. The hello control module 316 checks whether a RECORD_ROUTE object is attached to the received hello message (step 1901).

If a RECORD_ROUTE object is not attached, the hello control module 316 recognizes the recovery of the failure and modifies line information via the line management module 314 (step 1902). In this case, if a receiving node is the head end, the line information shown in FIG. 5 is updated from abnormal to normal. If the receiving node is a node other than the head end, the information of the relevant line shown in FIG. 6 is deleted.

Then, the hello control module 316 performs the same process as in steps 1503 and 1504 shown in FIG. 15, and transmits the same hello message as long as no new line failure or no recovery is detected (steps 1903 and 1904).

Such an operation at the time of the detection of a failure/recovery can be applied to fast reroute, which is a high-speed tunnel failure switching method. In that case, a node in which the respective start points of the active and standby systems of fast reroute performs all the processes performed by the above-mentioned head end. Therefore, in the network configuration shown in FIG. 4, core #A stores the line information shown in FIG. 5. Thus, core #A can recognize a line failure between core #B and core #C, and can switch an active tunnel to a standby tunnel.

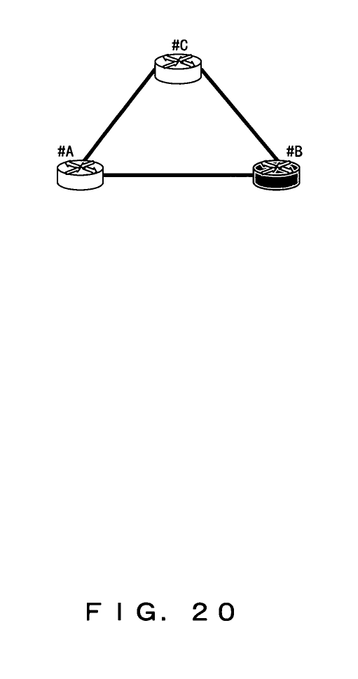

Next, a process of the case that there is a node in a network, which is not provided with the failure notification function of the present invention, is described in more detail with reference to FIGS. 20 through 24.

It is assumed that in the network configuration shown in FIG. 20, of three routers existing in a network, each of routers #A and #C is provided with the failure notification function of the present invention, and router #B is not provided with the function.

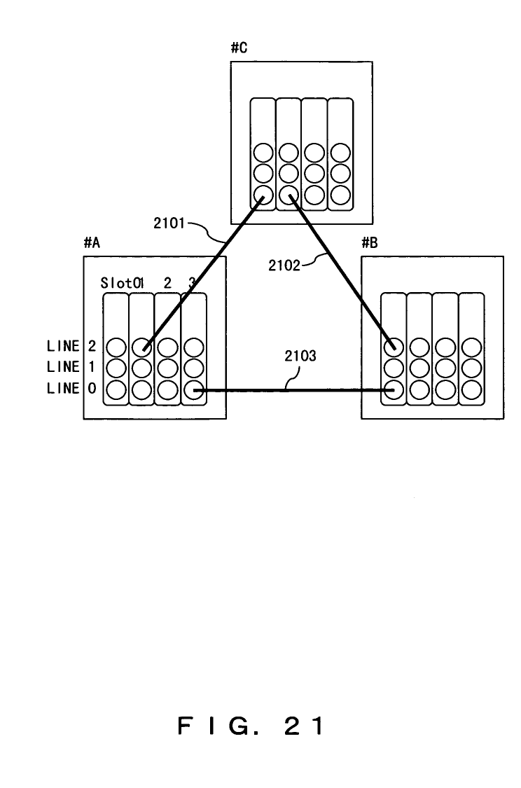

FIG. 21 shows a connection method between these routers. Each router is provided with a plurality of slots, and each slot has a plurality of line positions. When building a network, one line position of one router is physically connected to one line position of the other by cables 2101 through 2103.

Each router can specify a line position to which a cable is connected from the relevant router to an adjacent router by a publicly known art. For example, router #A recognizes a line position to which a cable 2101 is connected toward router #C and a line position to which a cable 2103 is connected toward router #B as (slot1, line2) and (slot3, line0), respectively. Routers #B and #C also recognize line positions similarly.

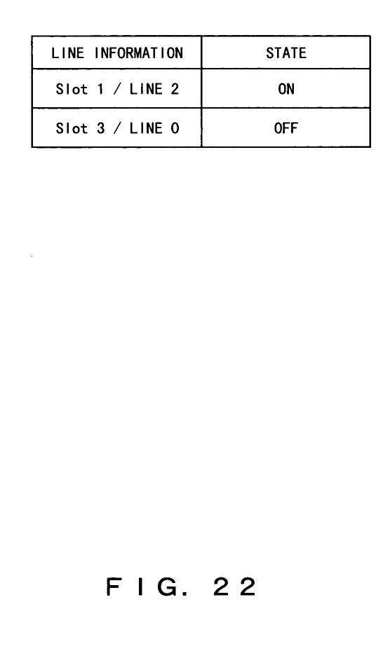

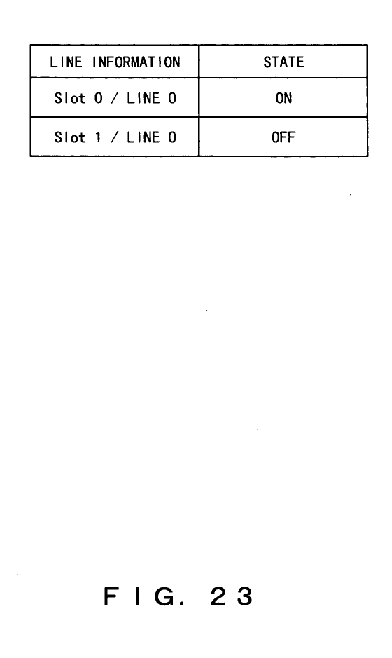

In this case, routers #A and #C store the management data shown in FIGS. 22 and 23, respectively, in memory. In the management data, “ON” indicates that a line is provided with the failure notification function of the present invention. “OFF” indicates that a line is not provided with the failure notification function. When receiving a message from an adjacent node, each of router #A and #C analyzes the value of flags in the common header shown in FIG. 11 and updates the value of management data.

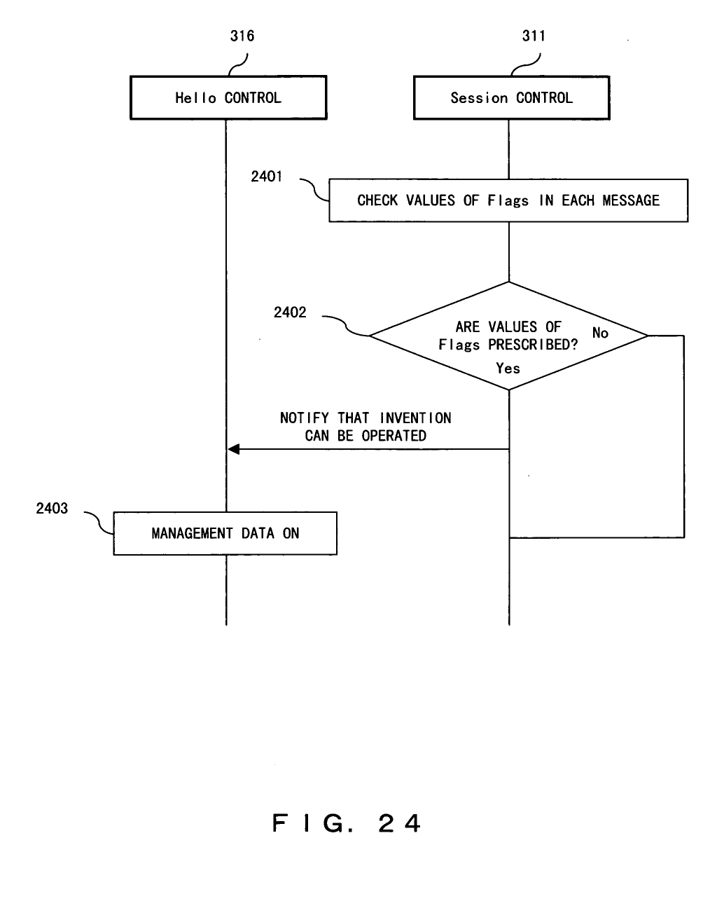

FIG. 24 is a flag analysis sequence chart at the time of the reception of such a message. Before transmitting a hello message, that is, when receiving a series of messages, such as a path message, resv message or the like, which are transmitted when establishing a tunnel, the session control module 311 of a node provided with the failure notification function checks a value included in the flags of the common header of each message (step 2401), and compares the value with a prescribed value (step 2402).

If the value of the flags coincides with the prescribed value, the session control module 311 notifies the hello control module 316 that the operation of the present invention is possible. Thus, the hello control module 316 determines that an adjacent node is provided with the failure notification function of the present invention, and updates the state of the relevant line in the management data of memory from “OFF” to “ON” via the line management module 314 (step 2403). After that, as to the relevant line, the operations of the present invention shown in FIGS. 15 through 19 are performed.

If the value of the flags does not coincide with the prescribed value, the session control module 311 notifies the hello control module 316 of nothing. In this case, the state of the relevant line in the management date becomes “OFF”, and as to the line, the conventional operation is performed.

1. A tunnel failure notification apparatus for notifying the occurrence of a tunnel failure in a communication network for transmitting packets using a tunnel, comprising:
a detection device for detecting the occurrence of a failure in a line of the communication network; and
a notification device for unifying the disconnection messages of a plurality of tunnels which pass through the failed line and notifying an adjacent node of the occurrence of the failure for each line.

2. The tunnel failure notification apparatus according to claim 1, further comprising
a storage device for storing the line information of the failed line, wherein
said notification device notifies the adjacent node of the occurrence of the failure when the line information is abnormal.

3. The tunnel failure notification apparatus according to claim 2, wherein
said storage device further stores management data indicating whether the adjacent node is provided with a failure notification function for each line, and
said notification device notifies the adjacent node of the occurrence of the failure for each line if the adjacent node is provided with the failure notification function, and notifies the adjacent node of the disconnection messages of the plurality of tunnels for each tunnel if the adjacent node is not provided with the failure notification function.

4. The tunnel failure notification apparatus according to claim 1 or 2, wherein
said detection device detects the recovery of the failure in the line, and
said notification device unifies the recovery messages of a plurality of tunnels which pass through the recovered line, and notifies the adjacent node of the recovery of the failure for each line.

5. A tunnel failure notification apparatus for notifying the occurrence of a tunnel failure in a communication network for transmitting packets using a tunnel, comprising:
a receiving device for receiving a failure notice that represents the disconnection messages of a plurality of tunnels which pass through a failed line and notifies the occurrence of a failure for each failed line from the first adjacent node when a failure occurs in the line of the communication network; and
a notification device for notifying the second adjacent node of the occurrence of the failure for each line, based on the received failure notice.

6. The tunnel failure notification apparatus according to claim 5, further comprising
a storage device for storing the line information of the failed line; wherein
said notification device notifies the second adjacent node of the occurrence of the failure when the line information is abnormal.

7. The tunnel failure notification apparatus according to claim 6, wherein
said storage device further stores management data indicating whether the second adjacent node is provided with a failure notification function for each line, and
said notification device notifies the second adjacent node of the occurrence of the failure for each line if the adjacent is provided with the failure notification function, and notifies the second adjacent node of the disconnection messages of the plurality of tunnels for each tunnel if the second adjacent node is not provided with the failure notification function.

8. The tunnel failure notification apparatus according to claim 5, wherein
said receiving device receives a recovery notice that represents the recovery messages of a plurality of tunnels which pass through the recovered line and notifies the recovery of the failure for each line from the first adjacent node, and
said notification device notifies the second adjacent node of the recovery of the failure, based on the received recovery notice.

9. A tunnel failure processing apparatus for disconnecting tunnels when a tunnel failure occurs in a communication network for transmitting packets using a tunnel, comprising:
a receiving device for receiving a failure notice that represents a plurality of disconnection messages of the tunnels which pass through a failed line and notifies the occurrence of a failure for each failed line from an adjacent node when the failure occurs in the line of a communication network; and
a control device for disconnecting a plurality of tunnels, based on the received failure notice and refraining from re-establishing the plurality of tunnels until receiving a recovery notice for notifying the recovery of the failure.

10. The tunnel failure processing apparatus according to claim 9, further comprising:
a storage device for storing the line information of a plurality of lines in the communication network; and
a line management device for modifying the line information of the failed line from normal to abnormal when receiving the failure notice, wherein
said control unit disconnects the plurality of tunnels when the line information of the failed line is modified to abnormal.

11. A tunnel failure processing apparatus for switching tunnels when a tunnel failure occurs in a communication network for transmitting packets using a tunnel, comprising:
a receiving device for receiving a failure notice that represents a plurality of tunnel disconnection messages of the tunnels which pass through a failed line and notifies the occurrence of a failure for each failed line from an adjacent node when the failure occurs in the line of a communication network; and
a control device for switching an active tunnel included in the plurality of tunnels to a standby tunnel which takes an alternative route, based on the received failure notice.

12. The tunnel processing apparatus according to claim 11, further comprising
a storage device for storing the line information of a plurality of lines in the communication network; and
a line management device for modifying the line information of the failed line from normal to abnormal when receiving the failure notice, wherein
said control unit switches the active tunnel to a standby tunnel when the line information of the failed line is modified to abnormal.

13. A tunnel failure notification method for notifying the occurrence of a tunnel failure in a communication network for transmitting packets using a tunnel, comprising:
detecting the occurrence of a failure in the line of the communication network; and
unifying the disconnection messages of a plurality of tunnels which pass through the failed line and notifying an adjacent node of the occurrence of the failure for each line.

14. A tunnel failure notification method for notifying the occurrence of a tunnel failure in a communication network for transmitting packets using a tunnel, comprising:
receiving a failure notice that represents the disconnection messages of a plurality of tunnels which pass through a failed line and notifies the occurrence of a failure for each failed line from the first adjacent node when a failure occurs in the line of the communication network; and
notifying the second adjacent node of the occurrence of the failure for each line, based on the received failure notice.

15. A tunnel failure processing method for disconnecting tunnels when a tunnel failure occurs in a communication network for transmitting packets using a tunnel, comprising:
receiving a failure notice that represents a plurality of disconnection messages of the tunnels which pass through a failed line and notifies the occurrence of a failure for each failed line from an adjacent node when the failure occurs in the line of a communication network; and
disconnecting a plurality of tunnels, based on the received failure notice and refraining from re-establishing the plurality of tunnels until receiving a recovery notice for notifying the recovery of the failure.

16. A tunnel failure processing method for disconnecting tunnels when a tunnel failure occurs in a communication network for transmitting packets using a tunnel, comprising:
receiving a failure notice that represents a plurality of disconnection messages of the tunnels which pass through a failed line and notifies the occurrence of a failure for each failed line from an adjacent node when the failure occurs in the line of a communication network; and
switching an active tunnel included in the plurality of tunnels to a standby tunnel which takes an alternative route, based on the received failure notice.

17. A computer-readable storage medium on which is recorded a program for enabling a processor to notify the occurrence of a tunnel failure in a communication network for transmitting packet using a tunnel, said program comprising:
detecting the occurrence of a failure in the line of the communication network; and
unifying the disconnection messages of a plurality of tunnels which pass through the failed line and notifying an adjacent node of the occurrence of the failure for each line.

18. A computer-readable storage medium on which is recorded a program for enabling a processor to notify the occurrence of a tunnel failure in a communication network for transmitting packet using a tunnel, said program comprising:
receiving a failure notice that represents the disconnection messages of a plurality of tunnels which pass through a failed line and notifies the occurrence of a failure for each failed line from the first adjacent node when a failure occurs in the line of the communication network; and
notifying the second adjacent node of the occurrence of the failure for each line, based on the received failure notice.

19. A computer-readable storage medium on which is recorded a program for enabling a processor to disconnect a tunnel when a tunnel failure occurs in a communication network for transmitting packet using a tunnel, said program comprising:
receiving a failure notice that represnts a plurality of disconnection messages of the tunnels which pass through a failed line and notifies the occurrence of a failure for each failed line from an adjacent node when the failure occurs in the line of a communication network; and
disconnecting a plurality of tunnels, based on the received failure notice and refraining from re-establishing the plurality of tunnels until receiving a recovery notice for notifying the recovery of the failure.

20. A computer-readable storage medium on which is recorded a program for enabling a processor to disconnect a tunnel when a tunnel failure occurs in a communication network for transmitting packet using a tunnel, said program comprising:
receiving a failure notice that represents a plurality of disconnection messages of the tunnels which pass through a failed line and notifies the occurrence of a failure for each failed line from an adjacent node when the failure occurs in the line of a communication network; and
switching an active tunnel included in the plurality of tunnels to a standby tunnel which takes an alternate route, based on the received failure notice.

21. A carrier signal for carrying a program for enabling a computer to notify the occurrence of a tunnel failure in a communication network for transmitting packet using a tunnel, said program comprising:
detecting the occurrence of a failure in the line of the communication network; and
unifying the disconnection messages of a plurality of tunnels which pass through the failed line and notifying an adjacent node of the occurrence of the failure for each line.

22. A carrier signal for carrying a program for enabling a processor to notify the occurrence of a tunnel failure in a communication network for transmitting packet using a tunnel, said program comprising:
receiving a failure notice that represents the disconnection messages of a plurality of tunnels which pass through a failed line and notifies the occurrence of a failure for each failed line from the first adjacent node when a failure occurs in the line of the communication network; and
notifying the second adjacent node of the occurrence of the failure for each line, based on the received failure notice.

23. A carrier signal for carrying a program for enabling a processor to disconnect a tunnel when a tunnel failure occurs in a communication network for transmitting packet using a tunnel, said program comprising:
receiving a failure notice that represents a plurality of disconnection messages of the tunnels which pass through a failed line and notifies the occurrence of a failure for each failed line from an adjacent node when the failure occurs in the line of a communication network; and disconnecting a plurality of tunnels, based on the received failure notice and refraining from re-establishing the plurality of tunnels until receiving a recovery notice for notifying the recovery of the failure.

24. A carrier signal for carrying a program for enabling a processor to disconnect a tunnel when a tunnel failure occurs in a communication network for transmitting packet using a tunnel, said program comprising:
receiving a failure notice that represents a plurality of disconnection messages of the tunnels which pass through a failed line and notifies the occurrence of a failure for each failed line from an adjacent node when the failure occurs in the line of a communication network; and
switching an active tunnel included in the plurality of tunnels to a standby tunnel which takes an alternate route, based on the received failure notice.

25. A tunnel failure notification apparatus for notifying the occurrence of a tunnel failure in a communication network for transmitting packets using a tunnel, comprising:
detection means for detecting the occurrence of a failure in the line of the communication network; and
notification means for unifying the disconnection messages of a plurality of tunnels which pass through the failed line and notifying an adjacent node of the occurrence of the failure for each line.

26. A tunnel failure notification apparatus for notifying the occurrence of a tunnel failure in a communication network for transmitting packets using a tunnel, comprising:
receiving means for receiving a failure notice that represents the disconnection messages of a plurality of tunnels which pass through a failed line and notifies the occurrence of a failure for each failed line from the first adjacent node when a failure occurs in the line of the communication network; and
notification means for notifying the second adjacent node of the occurrence of the failure for each line, based on the received failure notice.

27. A tunnel failure processing apparatus for disconnecting tunnels when a tunnel failure occurs in a communication network for transmitting packets using a tunnel, comprising:
receiving means for receiving a failure notice that represents a plurality of disconnection messages of the tunnels which pass through a failed line and notifies the occurrence of a failure for each failed line from an adjacent node when the failure occurs in the line of a communication network; and
control means for disconnecting a plurality of tunnels, based on the received failure notice and refraining from re-establishing the plurality of tunnels until receiving a recovery notice for notifying the recovery of the failure.

28. A tunnel failure processing apparatus for disconnecting tunnels when a tunnel failure occurs in a communication network for transmitting packets using a tunnel, comprising:
receiving means for receiving a failure notice that represents a plurality of disconnection messages of the tunnels which pass through a failed line and notifies the occurrence of a failure for each failed line from an adjacent node when the failure occurs in the line of a communication network; and
control means for switching an active tunnel included in the plurality of tunnels to a standby tunnel which takes an alternate route, based on the received failure notice.
